(19) United States
(12) Patent Application Publication
(10) Pub. No.: US 2025/0173768 A1
(43) Pub. Date: May 29, 2025

(54) SYSTEMS AND METHODS FOR GENERATING AND MANAGING INTERACTIVE VALUES OF ONLINE CONTENT IN ONLINE INTERACTIVE MEDIA DATA FEEDS

(71) Applicant: Caravan Ingredients Inc, Lenexa, KS (US)

(72) Inventors: Jennifer KULZER, Leneva, KS (US); Trent GREEN, Leneva, KS (US)

(21) Appl. No.: 18/960,086

(22) Filed: Nov. 26, 2024

Related U.S. Application Data
(60) Provisional application No. 63/603,976, filed on Nov. 29, 2023.

(51) Int. Cl. G06Q 30/0282

(52) U.S. Cl. CPC G06Q 30/0282

(57) ABSTRACT

Embodiments described herein include hardware and software components for a computing system that hosts, executes, or otherwise implements a software-based media configuration tool for managing software operations, configurations, content data, and other types content connection data of content connection efforts in which an organization transmits, uploads, or otherwise posts content data to interactive content media data feeds for the organization's accounts of online interactive media platforms, hosted on corresponding media servers of interactive media platforms. The data feed management tool includes a user interface that presents various types of information associated with prior or ongoing information content connections, such as interaction value data obtained from interactive media platforms or generated by the data feed or content media management tool.

### CROSS-REFERENCE TO RELATED APPLICATION

This application claims priority to US Provisional Application No. U.S. 63/603,976, filed Nov. 29, 2023, which is incorporated by reference in its entirety.

### TECHNICAL FIELD

This application generally relates to systems and methods for deploying and managing online content through automated collection and analysis of data obtained across disparate interactive media platforms.

### BACKGROUND

Organizational entities, such as companies, academic institutions, non-profit organizations, and governmental institutions, often launch and conduct online content connection efforts by posting content to various interactive media platforms. Sometimes, these organizations will employ third-party agencies to help conduct the content connection efforts. The organization orchestrates content postings according to the content connection's strategies. The interactive media platforms generate various interaction values associated with the content posts, indicating user interest and engagement with the organization's content data (e.g., posts, image data, video data, text data). For each interactive media platform, administrators of the organization's media platform accounts can access and review the report containing the interaction values for that particular interactive media platform. Based on the interaction values, the administrators of the organization's accounts may adjust or continue the content posts that are planned for the organization's interactive content media data feeds, as aligned with the content connection strategies.

There are, however, problems and technological shortcomings in conventional approaches to managing media content for interactive content connection efforts with users using interaction values provided by the interactive media platforms.

### SUMMARY

Interactive media platforms (such as online social media platforms) having any number of server computers or nodes that compute various interaction values (or metrics) (e.g., clickthrough rates, number of impressions) and generate reports for an organization having accounts with the interactive media platforms associated with concerted online content connection efforts (e.g., online content campaigns) of various types of online content connection programs. The types of interaction values may be tailored for the character of the particular interactive media platform. In many cases, the interactive media platforms provide disparate interaction values or otherwise superfluous interaction values that may not convey useful information to the particular organization. The content connection administrator might receive disparate types of interaction values from the media services, making cohesive assessment of an integrated content connection more difficult.

The organization may distribute administrative tasks and responsibility over a media feed across certain domains, such as geographic boundaries or regions. As an example, in North America, an administrative user may access an administrative web portal offered by an interactive media website (e.g., social media website). This administrator has access to the data and analytics captured during a content connection conducted at that interactive media platform. In this example, the organization allows teams outside of North America to handle accounts at online interactive media platforms (e.g., social media platforms) and content connections within dedicated geographic boundaries. For instance, in Europe, a marketing team may hire an agency and supplies the agency with the interaction values (or access to the interaction values) hosted at the media website of that online interactive media platform. The agency then generates a report on those analytics. Problems with this distributed approach to analyzing and responding to interaction values reports include disaggregated administration over content connection postings, disparate interaction values, and lack of access to certain interaction values available to other sub-organizations, among others.

What is needed is a means for gathering and analyzing interaction values data from disparate interactive media platforms indicating the performance of an organization's posts to the data media feeds. In particular, what is needed is a means for reconciling and normalizing disparate interaction values data and generating interaction values or scores that are contextually relevant to the intended purpose of a given content connection effort. Embodiments described herein include hardware and software components for a computing system that hosts, executes, or otherwise implements a software-based tool (sometimes referred to as a “social media management tool” or “social media configuration tool”) for managing software programs, configurations, and other content connection data of content connections in which an organization transmits, uploads, or otherwise posts content data to media data feeds for the organization's media platform accounts, hosted on corresponding interactive media servers of interactive media platforms. The data feed management tool includes a user interface that presents various types of information associated with prior or ongoing content connection efforts, such as interaction value data obtained from interactive media platforms or generated by the content management tool for content and data feed management.

In some embodiments, a computer-implemented method is implemented for managing, evaluating, and arranging content connection data at interactive media nodes or other types of computing systems (e.g., servers) hosting online interactive media platforms. The method includes transmitting, by a computer, a first post to a plurality of media servers hosting a plurality of online data feeds, the first post comprising content connection data configured for presentation at each online data feed; obtaining, by a computer, a plurality of interaction values associated with the first post from the plurality of media servers; selecting, by the computer, a set of interaction values from the plurality of interaction values according to one or more configurations, the set of interaction values includes a first type of interaction value obtained from a first media server and a second type of interaction value obtained from a second media server; generating, by the computer, a rating score for the first post by applying one or more configuration parameters on the set of interaction values, the one or more configuration parameters indicating a set of one or more weighting values assigned to the set of interaction values; and updating, by the computer, a user interface to include the rating score for display at a client device.

The computer may update the user interface based upon comparing the rating score against one or more threshold rating values.

Each interaction value data point of the set of interaction values may be assigned a weight value indicated by the one or more configurations. The computer generates the rating score in accordance with each weight value associated with each interaction value data point of the set of interaction values.

The method may include determining, by the computer, the set of one or more weighting values for the set of interaction values according to a type of content connection indicated by the one or more configurations.

The method may include normalizing, by the computer, a first interaction value data point and second interaction value data point of the first type of interaction value based upon a maximum value and a minimum value observed for the data type of interaction value in a historical dataset stored in a database.

The method may include computing, by the computer, an average value for the first type of interaction value using each interaction value data point of the first type of interaction value.

The method may include selecting, by the computer, a set of posts including the first post and a second post from a database containing a plurality of posts, the content connection data of the set of posts associated with a temporal configuration of the one or more configurations.

The method may include transmitting, by the computer, a second post of the set of posts to the plurality of media servers based upon comparing the rating score for the first post against a rating threshold.

The computer may transmit the second post to replace the first post at each online data feed of each media server.

The method may include receiving, by the computer, the one or more configurations from a client device via a configuration user interface.

The content connection data of each post may include at least one of image data, audio data, video data, text, or a hyperlink.

An interaction value of the set of interaction values includes at least one of an amount of impressions, an amount of clicks, an amount of leads, a clickthrough rate, a cost per click, a cost per impression, or a cost per lead.

In some embodiments, a system may manage, evaluate, or arrange content connection data at interactive media nodes or other types of computing systems (e.g., servers) hosting online interactive media platforms. The system comprises a computer comprising at least one processor and may be configured to transmit a first post to a plurality of media servers hosting a plurality of online data feeds, the first post comprising content connection data configured for presentation at each online data feed; obtain a plurality of interaction values associated with the first post from the plurality of media servers; select a set of interaction values from the plurality of interaction values according to one or more configurations, where the set of interaction values includes a first type of interaction value obtained from a first media server and a second type of interaction value obtained from a second media server; generate a rating score for the first post by applying one or more configuration parameters on the set of interaction values, the one or more configuration parameters indicating a set of one or more weighting values assigned to the set of interaction values; and update a user interface to include the rating score for display at a user device.

The computer may update the user interface based upon comparing the rating score against one or more threshold rating values.

Each interaction value data point of the set of interaction values is assigned a weight value indicated by the one or more configurations. The computer generates the rating score in accordance with each weight value associated with each interaction value data point of the set of interaction values.

The computer may be further configured to determine the set of one or more weighting values for the set of interaction values according to a type of content connection indicated by the one or more configurations.

The computer may be further configured to normalize a first interaction value data point and second interaction value data point of the first type of interaction value based upon a maximum value and a minimum value observed for the data type of interaction value in a historical dataset stored in a database.

The computer may be further configured to compute an average value for the first type of interaction value using each interaction value data point of the first type of interaction value.

The computer may be further configured to select a set of posts from a database, including the first post and a second post from a database containing a plurality of posts, the content connection data of the set of posts associated with a temporal configuration of the one or more configurations.

The computer may be further configured to transmit a second post of the set of posts to the plurality of media servers based upon comparing the rating score for the first post against a rating threshold.

The computer may transmit the second post to replace the first post at each online data feed of each media server.

The computer may be further configured to receive the one or more configurations from a client device via a configuration user interface.

The content connection data of each post may include at least one of image data, audio data, video data, text, or a hyperlink.

An interaction value of the set of interaction values may include at least one of an amount of impressions, an amount of clicks, an amount of leads, a clickthrough rate, a cost per click, a cost per impression, or a cost per lead.

In some embodiments, a non-transitory, computer-readable medium storing executable instructions for arranging connection data at interactive media nodes hosting online interactive media platforms that, when executed by one or more processors, cause the at least one processor to: transmit a first post to a plurality of interactive media nodes hosting a plurality of online data feeds, the first post comprising connection data configured for presentation at each online data feed; obtain a plurality of interaction values associated with the first post from the plurality of interactive media nodes; select a set of interaction values from the plurality of interaction values according to one or more configurations, wherein the set of interaction values includes a first type of interaction value obtained from a first interactive media node and a second type of interaction value obtained from a second interactive media node; generate a rating score for the first post by applying one or more configuration parameters on the set of interaction values, the one or more configuration parameters indicating a set of one or more weighting values assigned to the set of interaction values; and update a user interface to include the rating score for display at a user device.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components of a system implementing a software-based content media management tool for deploying and managing software operations, configurations, and data of content connection efforts on interactive media platforms, according to an embodiment.

FIG. 2 shows operations of an example method for evaluating content connection postings to media data feeds, according to an embodiment.

FIG. 3 shows an example user interface of a content media management tool, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Embodiments described herein include hardware and software components for a computing system that hosts, executes, or otherwise implements an interactive content media configuration tool (e.g., social media feed configuration tool) for managing software routines, configurations, and other types of content connection data of the content connection efforts in which an organization transmits, uploads, or otherwise posts content data to interactive media data feeds for the organization's interactive media platform media accounts, hosted on corresponding media servers of interactive media platforms. The content media management tool includes a user interface that presents various types of information or content connection data associated with prior or ongoing content connection efforts, such as interaction value data obtained from interactive media platforms or generated by the content media management tool.

In some embodiments, the software and hardware components of a computing system (including one or more computers or nodes) implement one or more machine-learning architectures. The programming of the machine-learning architectures includes any type of machine-learning models and techniques for performing the various operations for implementing software routines and functions of a content connection effort via one or more interactive media platforms. In some implementations, the machine-learning architecture includes a neural network architecture trained on interaction values data that the computing system receives from the interactive media platforms and any additional interaction values generated by the computing system. The computing system trains the neural network architecture using the data received from the interaction scoring functions described herein to “teach” the neural network architecture. During training, the computer executes machine-learning functions, such as a loss function, to adjust hyperparameters or weights of the machine-learning architecture. In some cases, the machine-learning architecture may be trained on the interaction values data or additional computed data received from the content interaction or content connection scoring functions described herein to train the system on which changes or configurations in one or more, prior or ongoing, content connections are “negative” or “positive,” as indicated by training labels. The values of the training labels may be automatically or manually configured by the computer or user inputs. In some instances, the values of the training may be determined based upon a scientific experimentation methodology that compares a control group of configurations or results against a variable group of configurations or results. After the training phase, the computer may instruct the machine-learning architecture to enter a deployment (or “inference”) phase, after the training phase. The content media management tool may execute and invoke the machine-learning architecture during the deployment phase to generate and update the operations, associated data, and configurations of the software routines and functions of the content connection effort based upon the outputs generated by the machine-learning architecture.

When the content media tool invokes the machine-learning architecture, the machine-learning architecture provides targeted suggestions for the content connection based upon the trained hyperparameters and weights. In some cases, the machine-learning architecture may also generate the content connection data or other types of outputs that may suggest using, for example, various forms of demographical and physiological information. The machine-learning architecture may perform the machine-learning operations (e.g., backpropagation, tuning hyperparameters or weights) on an ongoing basis, in real-time or at preconfigured interval. In this way, the more that the media tool is used, the “smarter” or better-fitted the machine-learning architecture becomes. Moreover, the media tool generates the basic scores based on the content connection effort's particular configurations or the enterprise organizations particular preferences (e.g., the configurations, such as the weights, are established based on the organization's preferences within the content media tool). As such, the content connection suggestions produced by the trained and tuned machine-learning architecture are closely, and increasingly, tailored to the enterprise organization and/or the content connection.

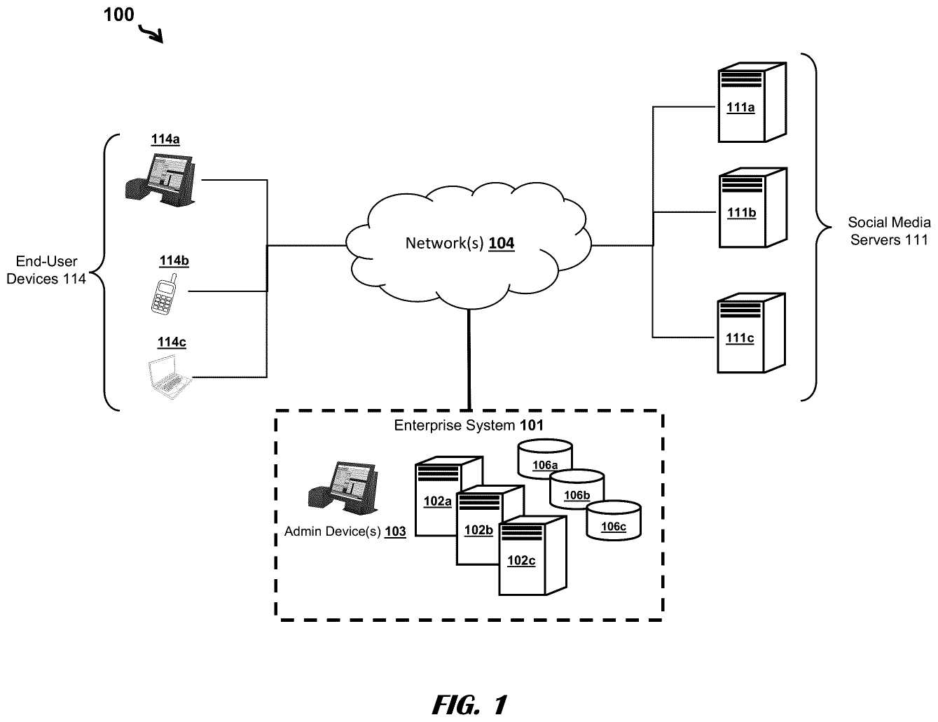

FIG. 1 shows components of a system 100 implementing a software tool for deploying and managing software operations for implementing content connection efforts on interactive media platforms (e.g., social media platforms), according to an embodiment. The system 100 includes an enterprise system 101 of an enterprise organization, interactive media servers 111a-111c (generally referred to as media servers 111 or a media server 111), and end-user devices 114a-114c (generally referred to as end-user devices 114 or an end-user device 114). In some cases, the media servers 111 may be referred to as nodes of the interactive media platform. The enterprise system 101 includes application servers 102a-102c (generally referred to as application servers 102 or an application server 102), content connection databases 106a-106c (generally referred to as content connection databases 106 or a content connection database 106), and any number of admin devices 103. For case of description and understanding, the system 100 is described and shown in FIG. 1 as having only one or a few instances of the various components. It should, however, be appreciated that embodiments may include any number of the components described herein. It should be further appreciated that embodiments may comprise additional or alternative components, or may omit certain components, and still fall within the scope of this disclosure.

The hardware and software components of the system 100 may communicate with one another via one or more networks 104. The networks 104 may include any number of public networks and/or private networks. The network 104 may comprise hardware and software components implementing various networking and/or telecommunications protocols facilitating communications between various devices, which may include devices of the system 100 or any number of additional or alternative devices not shown in FIG. 1. The network 104 may be implemented as a cellular network, a Wi-Fi network, or other wired local area network (LAN) or wireless LAN, a WiMAX network or other wireless or wired wide area network (WAN), and the like. The networks 104 may also communicate with external servers of other external services coupled to the networks 104.

The end-user devices 114 include any electronic devices comprising hardware components and software components capable of performing the various processes and tasks described herein. Non-limiting examples of end-user devices 114 include workstation computers 114a, mobile phones 114b, laptop 114c, or tablet device, among others. The system 100 comprises any number of end-user devices 114 that communicate with the media servers 111 by accessing webpages or other web-based application hosted at a webserver program of the media server 111.

The end-user device 114 executes a software application for navigating the webpages or other format of interactive media data feeds hosted by the media servers 111, where the software application could be a web browser (e.g., Chrome®, Firefox®, Internet Explorer®) that accesses the websites hosted by the media servers 111 of the interactive media platforms, or the software application includes a native application (e.g., connection app or social media app) published by (or otherwise associated with) the interactive media platform and installed on the end-user device 114. When the end-user navigates the browser or native app to the media server 111 of the interactive media platform to access the interactive media data feed, the end-user device 114 connects to the media server 111 hosting the particular media data feed, using one or more IP Addresses that the end-user device 114 obtains by translating a domain name for the media server 111. When the end-user device 114 accesses the media server 111, the media server 111 returns personalized content (e.g., interactive content data feed or social media feed) or a listing of available content. As an example, as the end-users interact with social media content (e.g., posts, profiles), the media server 111 executes software programming for detecting, tracking, and analyzing the end-user interactions with each particular content post and computing interaction values for the content posts. The media server 111 then generates interaction values data, which the media server 111 may store into a corresponding media database (not shown) of the interactive media platform.

The media servers 111 may include any computing devices comprising hardware and software components for performing the various processes and tasks described herein. The media servers 111 include software programming defining a webserver program (e.g., Apache®, Microsoft IIS®) or similar software programming for executing operations of a web-application that hosts a interactive media platform. The interactive media platform includes the media data feeds generated by the media servers 111 according to various content-selection functions. When executing such operations, the media server 111 selects content (e.g., postings, profiles) from a media database of the interactive media platform to transmit to the end-user device 114 over the networks 104, and presents the selected content at a user interface of the end-user device end-user device 114. The media server 111 may also retrieve and present certain content or media data feeds to the end-user device 114, in response to input requests, received from the end-user device 114, containing instructions or selections indicating certain content that the end-user would like to view.

The media server 111 executes programming for capturing interaction information between the end-user device 114 and the interactive content media server 111, thereby tracking the behaviors of the end-user. The interaction information generated by the media server 111 includes, for example, indicators of content selected or requested by the end-user, and an amount of time the end-user viewed content in the user interface, among others. The media server 111 may tailor the end-user's experience using this interaction information. In addition, the media server 111 may generate the interaction values data for the content of a particular organization. For instance, the media server 111 by tracking when each end-user requests and accesses a particular posting of the organization, the media server 111 may tabulate interaction value data indicating, for example, a number of end-users who accessed the particular. The media server 111 may compute various types of interaction values when generating the interaction values data. The media server 111 may store the interaction values data associated with the particular organization and/or associated with the particular interactive media content posting into the media database of the interactive media platform. The media server 111 generates interaction values data and outputs a interaction values report containing the interaction values data produced by the particular interactive media platform.

The media server 111 may execute programming for generating and hosting an administrative web portal. The administration portal includes features and functions for an administrator user associated with an organization and the organization's enterprise system 101 to manage the content postings on the particular media server 111. The administrator user may access and review the interaction values report or interaction values data via the administration portal. The admin device 103 establishes a secure connection with the webserver of the media server 111 to establish the web portal session, accesses or requests the interaction values report or interaction values data, and downloads or streams, over the networks 104, the interaction values report from the media server 111. Optionally, in some embodiments, the application server 102 of the enterprise system 101 may execute software programming for accessing and downloading the interaction values report from the media server 111.

The enterprise system 101 is a computing network infrastructure associated with an enterprise organization (e.g., company, university, government entity) or individual. The enterprise organization utilizes one or more interactive media services, hosted on the media servers 111, for promoting or publishing information. The analytics servers 102 publish or upload data to the media servers 111 via the one or more networks 105. The media servers 111 capture interaction values data indicating levels of interactions between the end-user devices 114 and the online content and information published to the interactive content media outputs or data feeds.

The admin devices 103 include client computing devices of the administrative users of the organization to manage aspects of the enterprise system 101 or the various operations, associated data, and configurations of the software routines implementing the content connection effort conducted through the interactive media platforms. The admin devices 103 may include any computing devices comprising hardware and software components capable of performing the various processes and tasks described herein. Non-limiting examples of the admin device 103 includes a personal computer (e.g., workstation desktop computer, laptop computer), mobile device, tablet, or the like. In operation, the admin device 103 includes hardware and software programming for accessing the media servers 111 or the application servers 102.

In some cases, the administrator operates the admin device 103 to configure and manage the organization's content data posted to the media servers 111. The admin device 103 and/or the application server 102 includes a software program (e.g., web browser, native app) that accesses the organization's online platform accounts and the media data feeds, as hosted at the media servers 111 over the networks 104. As an example, when the administrator user elects to submit a post to the media server 111, on the landing the page (or any other page of the interactive content media website), the administrator enters an instruction via a user interface element (e.g., button) to the browser that instructs the browser to send a request to enter the post to the webserver of the media server 111. The media server 111 will return updated webpage content that, for example, activates a text field or other interactive user interface element, allowing the end-user to enter, upload, or create the intended post. Moreover, the admin device 103 or application server 102 may access the administrative portal or enhanced services hosted by each particular media server 111, allowing the administrator to arrange and configure the content, interaction values, or other features and of the software routines of the content connection effort at the media server 111. The admin device 103 or application server 102 may access or download the interaction values report or interaction values data associated with the organization's content postings.

The admin device 103 includes software programming for executing a client-side media management tool or accessing the media management tool hosted at the application server 102. The content media management tool may include a web-based application having data or functions hosted and executed at the application server 102 and/or the admin device 103. In some embodiments, the admin device 103 executes a native and locally executed instance of the content media management tool that accesses and interacts with programming of the application server 102. In some embodiments, the admin device 103 executes a web browser that accesses a web-based media management tool hosted at the application server 102. In such embodiments, the media management tool is entirely or almost entirely web-based as executed at the application server 102.

It should be appreciated that embodiments need not include application servers 102 or admin devices 103 to execute the media management tool. For instance, the features described herein with respect to the media management tool may be perform entirely at the application server 102 or entirely at the admin device 103, or the features of the media management tool may be distributed and performed in any combination involving the application server 102 and the admin device 103.

The application server 102 may include any computing device comprising hardware and software components capable of performing the various processes and tasks described herein. The application server 102 may execute software programming for a server-side content media configuration tool. In some implementations, the application server 102 executes software programming for a webserver or similar programming for hosting the media configuration tool as a web-based application accessible to the admin devices 103. Generally, the content media management tool allows the administrator to manage aspects of the software implementing the content connection at a single user interface across multiple interactive media platforms. The media management tool may present, generate, update, or otherwise provide various interactive user interfaces to the administrator. The administrator may operate the media management tool in order to, for example, enter content connection configurations and review content connection results (e.g., access or retrieve stored instances of interaction values or report files). In some embodiments, the application server 102 or admin device 103 may be configured to automatically push additional content connection-related posting to one or more media servers 111 according to a pre-configured temporal factor (e.g., hourly, daily, weekly).

The content connection parameters may indicate configurations for the various operations performed by the media content connection tool, as executed by the application server 102 or admin device 103. The content connection content data includes various types of content data and metadata included in content connection posts, which may include historic posts of content that was previously posted to the media data feeds or scheduled posts of content to be posted to the media data feeds at the media servers 111. The application server 102 or admin device 103 may store the content connection parameters and content connection content into the content connection database 106.

In some implementations, the application server 102 may execute the various processes for configuring content connection data and content connection parameters according to inputs or instructions from the admin device 103. The application server 102 may store the content connection data and content connection parameters into one or more content connection databases 106 of the enterprise system 101. The content connection parameters indicate configurations for the various operations performed by the application server 102 or other computing resource of the enterprise system 101. The content connection content data includes various types of content data and metadata included in content connection posts, previously posted to the media data feeds or scheduled for posting to the media data feeds, as hosted at the media servers 111. In some implementations, the administrative user executes software programming on the admin device 103, such as a browser or a client-side instance of the media configuration tool, in order to access the user interface and configuration options of the media configuration tool hosted on the application server 102. Non-limiting examples of the content connection parameters includes a type of content connection, content connection goals, weights for interaction values, core interaction values (e.g., clickthrough rate, clicks, impressions), averaged interaction values, optional custom interaction values, and thresholds values, among other types of configurable parameters for managing the operations, data, and configurations for the software programming of the content connection via one or more interactive media platforms, as hosted on one or more media servers 111. The application server 102 receives the configurations as user configuration inputs from the admin device 103, via the user interface of the browser or media configuration tool at the admin device 103.

The configurations in the content connection parameters may indicate which types of interaction values are used by the application server 102 in downstream operations, such as computing averages or generating additional types of custom interaction values. Oftentimes, conventional approaches to media management lack a means for customizing, integrating, reconciling, or otherwise analyzing interaction values across multiple interactive media platforms in order to handle software operations of a content connection. The content connection parameters may indicate a type of content connection. The content connection type refers and relates to, for example, an overall goal or purpose of the operations of the content connection. Non-limiting examples of potential content connection types include lead generation, brand image development, and brand awareness. Downstream operations that, for example, generate content connection scores or evaluate content connection effectiveness may be relative to the content connection type. The content connection parameters may indicate and assign weights to interaction values data, which the media management tool references when computing a content connection score (sometimes referred to as a “rating score”). In some cases, the user enters one or more user inputs that expressly indicate the weights. In some cases, the application server 102 or admin device 103 is preprogramed to assign the weights based upon the content connection type indicated by the content connection parameters. The user configuring the content connection may operate the admin device 103 to submit configuration inputs to the application server 102 containing configurations indicating weighting values, which the user may assign or otherwise configure for the content connection based upon, for example, organizational needs and values to achieve media goals of the content connection. For instance, certain types of interaction values are comparatively more important when evaluating the effectiveness of a lead generation content connection while other types of interaction values are comparatively less important.

Ordinarily, an administrator may access information and configure the content connection parameters at web portals or web-applications of disparate media servers 111. For instance, an administrator might operate the admin device 103 to access content connection manager interfaces through various interactive media platforms (e.g., LinkedIn®, Instagram®, YouTube®, Facebook®). These conventional content connection manager services may provide various basic interaction values, some of which are the same type of interaction values across two or more interactive media platforms. In some embodiments, the administrator may use the media configuration tool to instruct or configure the application server 102 or the admin device 103 to retrieve the interaction values reports from the several media servers 111 and perform additional operations in accordance with the content connection parameters, which beneficially causes the application server 102 or admin device 103 to access and prepare integrated and contextually relevant interaction values for the software functions of the content connection, according to the type of content connection.

The media configuration tool, executed by the application server 102 or admin device 103, may normalize certain selected types of interaction values of the interaction value data obtained from the media servers 111. Certain types of interaction values may be configured as core or key, which are typically common types of interaction values (e.g., type of metrics for device or user interactions with content) provided from two or content media servers. In some implementations, for the key interaction values, the media configuration tool determines a maximum potential and minimum potential from interaction values data across one or more ongoing or prior content connections and/or across one or more interactive media platforms, by querying the historic datasets stored in the content connection databases 106. The media configuration tool may reference the minimums and maximums (min-max) to normalize the interaction values across the key interaction values data from one or more interactive media platforms and/or one or more content connections. The media configuration tool then outputs an integrated, normalized interaction value for the particular type of interaction value.

In some embodiments, the enterprise system 101 comprises geographically disparate application servers 102 and corresponding content connection databases 106. In such embodiments, it may be preferable to have geographically tailored content connection parameters or content connection data. For instance, certain jurisdictions may have different interactive media platform offerings available to the targeted end-users, or the content data for a global or local content connection may be tailored according to the particular geography. The application servers 102 may receive and analyze the geographically disparate interaction values reports and interaction values data from the media servers 111.

The interaction values data may be generated and hosted on the media servers 111 accessible to the application server 102 or admin device 103, via the one or more networks 104. A interaction values report from a particular media server 111 or media database contains the various types of interaction values data. The interaction values report may be the form of a computer-readable computer file (e.g., PDF document, HTML page) or a data stream or feed. The media configuration tool of the application server 102 or admin device 103 may automatically obtain the interaction values data according to one or more content connection configurations that indicate, for example, a preconfigured interval (e.g., daily, monthly, quarterly) or triggering condition instructing the application server 102 to retrieve the interaction values data from one or more media servers 111. The application server 102 or admin device 103 may manually obtain the interaction values report or the interaction values data in response to an instruction received in a user input via a user interface of the application server 102 or admin device 103, which may store the interaction values reports into the content connection database 106. The application server 102 or admin device 103 may obtain the interaction values data by fetching or requesting the interaction values data from the media server 111, and then downloading or accessing the interaction values report containing the interaction values data using communication standards (e.g., HTML, TCP/IP) and address pointers (e.g., IP addresses, URLs, DNS domains) associated with the media servers 111 corresponding to the communication standards. Additionally or alternatively, the server application server 102 or admin device 103 obtain the interaction values data from a media server as a interaction values report that the media server 111 uploaded, streamed, or otherwise “pushed” to the application server 102 or admin device 103.

The content connection databases 106 may be hosted on any computing devices comprising non-transitory machine-readable storage, software, and hardware components capable of performing the various processes and tasks described herein. The content connection databases 106 store, for example, content connection parameters, content connection content data, and interaction values reports, among other types of data. The application server 102 or admin device 103 may receive the content connection data from the administrator, and the application server 102 or admin device 103 may store the content connection data into the content connection database 106 associated with the particular application server 102 or admin device 103. The content connection data may include various types of data (e.g., text data, hyperlinks, media data, image data, video data) that may be included in online interactive media postings. The server or the client device may post or upload the content data to the media server, which include the content data to the media database and the media data feeds presented to the end-users of the interactive media platforms.

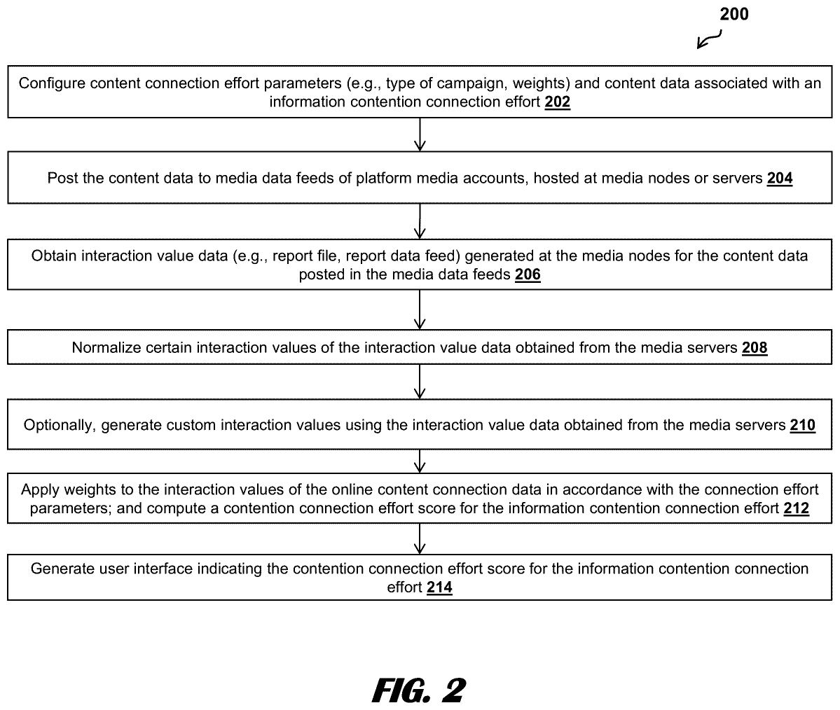

FIG. 2 shows operations of an example method 200 for evaluating content connection postings to online content media data feeds, hosted on interactive media nodes or media servers of an interactive media platform (e.g., social media servers of a social media platform). As described in FIG. 2, the operations of the method 200 are performed by a server or node (e.g., application server 102) hosting a web-based software application including software programming of an online content media management tool. The server communicates various types of data (e.g., data inputs, configuration inputs, executable instructions) to and from client devices of administrators and media servers, among other computing resources. Embodiments, however, are limited to one server performing the operations described herein.

In operation 202, the server configures content connection effort parameters and content data (e.g., image data, audio data, text data) of an online content connection effort, where the server may receive configuration inputs indicating content or parameters from a client device (e.g., admin device 103). The parameters of the content connection effort indicate configurations for the various operations performed by the server or other computing resource. The content data includes various types of content data and metadata included in content posts of the ongoing content connection effort, previously posted to the media data feeds (e.g., social media feeds) or scheduled for posting to the media data feeds. The administrative user executes software programming on the client device, such as a browser or client-side instance of the media configuration tool, in order to access the user interface and configuration options of the media configuration tool hosted on the server. In some cases, the server receives the configurations as user configuration inputs from the client device, via the user interface presented at the client device.

The content connection parameters may indicate a type of content connection effort, program, or routine. The content connection type refers and relates to, for example, an overall goal or purpose of the content connection. Non-limiting examples of potential types of content connection efforts or programs include lead generation, brand image development, and brand awareness. Downstream operations that, for example, generate content connection scores or evaluate content connection effectiveness may be relative to the type of content connection efforts or programs.

The content connection parameters may indicate and assign weights to interaction values data, which the server references when computing the content connection score. In some cases, the user enters one or more user inputs that expressly indicate the weights. In some cases, the server is preprogramed to assign the weights based upon the content connection type indicated by the content connection parameters. For instance, certain types of interaction values are comparatively more important when evaluating the effectiveness of a lead generation content connection while other types of interaction values are comparatively less important.

In operation 204, the server posts the content data to media data feeds of platform media accounts, hosted at media servers (or nodes). The server or user device may receive the content connection data from the administrator, where the content connection data may include various types of data (e.g., text data, hyperlinks or other uniform resource locator (URL), media data). The server or the client device may post or upload the content data to the media server, which include the content data to the media database and the media data feeds presented to the end-users of the interactive media platforms.

In operation 206, the server obtains interaction values data (e.g., report file, report data feed) generated at the media servers for the content connection data posted in the media data feeds. As mentioned, the interaction values data may be generated and hosted on the media servers accessible to the server or client device of an administrator, via the one or more networks. An interaction values report containing the interaction values data may be in the form of a computer-readable computer file (e.g., PDF document, HTML page) or a data stream or feed. The server may automatically obtain the interaction values data according to one or more content connection configurations that indicate, for example, a preconfigured interval (e.g., daily, monthly, quarterly) or triggering condition instructing the server to retrieve the interaction values data from one or more media servers. The server may manually obtain the interaction values data in response to an instruction received in a user input via a user interface of the client device. The server may obtain the interaction values data by fetching or requesting the interaction values data from the media server, and downloads or accesses the interaction values report containing the interaction values data using communication standards (e.g., HTML, TCP/IP) and address pointers (e.g., IP addresses, URLs, DNS domains) associated with the media servers corresponding to the communication standards. Additionally or alternatively, the server may obtain the interaction values data from a media server as a interaction values report that the media server uploaded, streamed, or otherwise pushed to the server.

In operation 208, the server normalizes certain interaction values of the interaction values data obtained from the media servers. As mentioned, certain types of interaction values may be configured as core or key, which are typically common types of interaction values provided from two or media servers. In some implementations, for the key interaction values, the server determines a maximum potential and minimum potential from interaction values data across one or more ongoing or prior content connections and/or across one or more interactive media platforms. The server may further compare the maximum against the minimum potentials of the different interactive media platforms. The server may reference the minimums and maximums (min-max) to normalize the interaction values across the key interaction values data from one or more interactive media platforms and/or one or more content connections. For instance, after the server has the interaction values data points of a plurality of interactive media platforms (e.g., LinkedIn®, Instagram®, Google®), the server may normalize and/or offset the interaction values as inputted, and thus generate integrated interaction values extrapolated from the normalized interaction values. For example, if the content connection utilized only one interactive media platform, then the server would normalize the interaction values data for just the min-max observed for that particular interactive media platform.

Optionally, in operation 210, the server generates custom interaction values using the interaction values data obtained from the media servers. Non-limiting examples may include averages of a particular type of interaction value or cost-per-click for content connection postings.

In operation 212, the server applies weights to the interaction values in accordance with the content connection parameters (e.g., weights, content connection type). The server then computes a content connection score for the content connection. After generating and normalizing the various types of interaction values, the server applies the weights indicated by the content connection parameter and totals (or other calculates) the weighted interaction values to output the content connection score.

In this way, the interaction values data produced by the media configuration tool described herein beneficially computes and provides more detailed and relevant information indicating the effectiveness of the content connection. Conventional approaches provide sufficient information indicating whether a content connection is generally effective or ineffective. For instance, the interaction values report from LinkedIn® contain data points indicating whether end-users are interacting with the content connection posts, and thus indicate a broad notion of whether the content connection is effective, without any context to the content connection's purpose. The media management tool described herein computes, normalizes, and weights the interaction values data to compute the content connection score relative to, for example, the goal of the content connection.

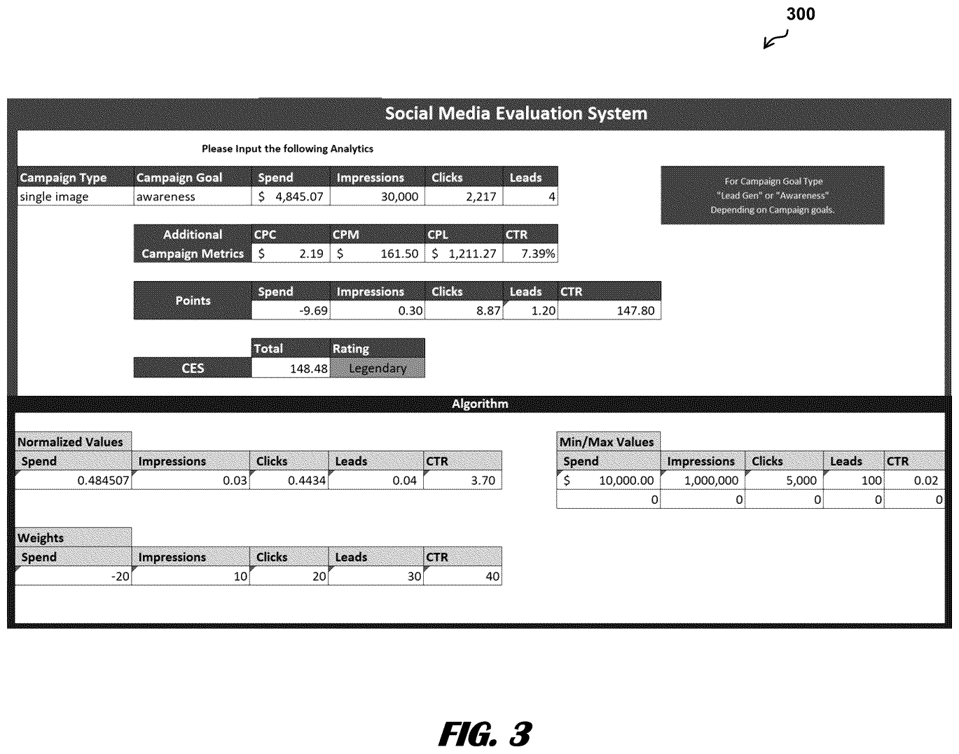

In operation 214, the server generates or updates a user interface of the media management tool presented at the client or user device. With reference to FIG. 3, which shows an example user interface 300 of the online interactive content media management tool described herein, the user interface 300 may be updated to indicate and display the content connection effort score for the content data. As shown in FIG. 3, in some implementations, the server may generate or update the user interface 300 to include various types of interaction values data, in addition to the content connection score.

Optionally, in some embodiments, the server may compare the content connection score against one or more threshold values to perform corresponding actions. In some cases, for example, the thresholds may correspond to rating tiers, such that the user interface presents the tier based upon the thresholds of each respective rating tiers. In another example, the server may be configured to transmit one or more updated or replacement postings to the media servers in response to determining that the postings associated with the content connection have thus far produced a content connection rating score that satisfies or fails a preconfigured rating score. As another example, if the server determines that the content connection score satisfies an intermediate tier threshold, then no action is taken; if the server determines that the content connection scores satisfies a highest-tier threshold, then the server generates a notification or indicator to increase spending on the content connection; and if the server determines that the content connection scores satisfies a lowest-tier threshold, then server generates a notification or indicator to decrease or halt spending on the content connection.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for arranging content connection data at interactive media nodes hosting online interactive media platforms, the method comprising:
transmitting, by a computer, a first post to a plurality of interactive media nodes hosting a plurality of online data feeds, the first post comprising connection data configured for presentation at each online data feed;
obtaining, by a computer, a plurality of interaction values associated with the first post from the plurality of interactive media nodes;
selecting, by the computer, a set of interaction values from the plurality of interaction values according to one or more configurations, wherein the set of interaction values includes a first type of interaction value obtained from a first interactive media node and a second type of interaction value in obtained from a second interactive media node;
generating, by the computer, a rating score for the first post by applying one or more configuration parameters on the set of interaction values, the one or more configuration parameters indicating a set of one or more weighting values assigned to the set of interaction values; and
updating, by the computer, a user interface to include the rating score for display at a user device.

2. The method according to claim 1, wherein the user interface is updated by the computer based upon comparing the rating score against one or more threshold rating values.

3. The method according to claim 1, wherein each interaction value data point of the set of interaction values is assigned a weight value indicated by the one or more configurations, and wherein the computer generates the rating score in accordance with each weight value associated with each interaction value data point of the set of interaction values.

4. The method according to claim 1, further comprising determining, by the computer, the set of one or more weighting values for the set of interaction values according to a type of connection program indicated by the one or more configurations.

5. The method according to claim 1, further comprising normalizing, by the computer, a first value data point and second value data point of the first type of interaction value based upon a maximum value and a minimum value observed for the first type of the interaction value in a historical dataset stored in a database.

6. The method according to claim 1, further comprising computing, by the computer, an average value for the first type of interaction value using each interaction value data point of the first type of interaction value.

7. The method according to claim 1, further comprising selecting, by the computer, a set of posts including the first post and a second post from a database containing a plurality of posts, the connection data of the set of posts associated with a temporal configuration of the one or more configurations.

8. The method according to claim 1, further comprising transmitting, by the computer, a second post of the set of posts to the plurality of interactive media nodes based upon comparing the rating score for the first post against a rating threshold.

9. The method according to claim 8, wherein the computer transmits the second post to replace the first post at each online data feed of each interactive media node.

10. The method according to claim 1, further comprising receiving, by the computer, the one or more configurations from the user device via a configuration user interface.

11. The method according to claim 1, wherein the connection data of each post includes at least one of image data, audio data, video data, text, or a uniform resource identifier.

12. The method according to claim 1, wherein an interaction value of the set of interaction values includes at least one of an amount of clicks, an amount of leads, a clickthrough rate, a cost per click, a cost per impression, or a cost per lead.

13. A system for arranging content connection data at interactive media nodes hosting online interactive media platforms, the system comprising:
a computer comprising at least one processor configured to:
transmit a first post to a plurality of interactive media nodes hosting a plurality of online data feeds, the first post comprising connection data configured for presentation at each online data feed;
obtain a plurality of interaction values associated with the first post from the plurality of interactive media nodes;
select a set of interaction values from the plurality of interaction values according to one or more configurations, wherein the set of interaction values includes a first type of interaction value obtained from a first interactive media node and a second type of interaction value obtained from a second interactive media node;
generate a rating score for the first post by applying one or more configuration parameters on the set of interaction values, the one or more configuration parameters indicating a set of one or more weighting values assigned to the set of interaction values; and
update a user interface to include the rating score for display at a user device.

14. The system according to claim 13, wherein the user interface is updated by the computer based upon comparing the rating score against one or more threshold rating values.

15. The system according to claim 13, wherein each interaction value data point of the set of interaction values is assigned a weight value indicated by the one or more configurations, and wherein the computer generates the rating score in accordance with each weight value associated with each interaction value data point of the set of interaction values.

16. The system according to claim 13, wherein the computer is further configured to determine the set of one or more weighting values for the set of interaction values according to a type of connection program indicated by the one or more configurations.

17. The system according to claim 13, wherein the computer is further configured to normalize a first interaction value data point and second interaction value data point of the first type of interaction value based upon a maximum value and a minimum value observed for the first type of interaction value in a historical dataset stored in a database.

18. The system according to claim 13, wherein the computer is further configured to compute an average value for the first type of interaction value using each interaction value data point of the first type of interaction value.

19. The system according to claim 13, wherein the computer is further configured to select a set of posts from a database, including the first post and a second post from a database containing a plurality of posts, the connection data of the set of posts associated with a temporal configuration of the one or more configurations.

20. The system according to claim 13, wherein the computer is further configured to transmit a second post of the set of posts to the plurality of interactive media nodes based upon comparing the rating score for the first post against a rating threshold.

21. The system according to claim 20, wherein the computer transmits the second post to replace the first post at each online data feed of each interactive media node.

22. The system according to claim 13, wherein the computer is further configured to receive the one or more configurations from the user device via a configuration user interface.

23. The system according to claim 13, wherein the connection data of each post includes at least one of image data, audio data, video data, text, or a uniform resource identifier.

24. The system according to claim 13, wherein an interaction value of the set of interaction values includes at least one of an of amount of clicks, an amount of leads, a clickthrough rate, a cost per click, a cost per impression, or a cost per lead.

25. A non-transitory, computer-readable medium storing executable instructions for arranging connection data at interactive media nodes hosting online interactive media platforms that, when executed by one or more processors, cause the at least one processor to:
transmit a first post to a plurality of interactive media nodes hosting a plurality of online data feeds, the first post comprising connection data configured for presentation at each online data feed;
obtain a plurality of interaction values associated with the first post from the plurality of interactive media nodes;
select a set of interaction values from the plurality of interaction values according to one or more configurations, wherein the set of interaction values includes a first type of interaction value obtained from a first interactive media node and a second type of interaction value obtained from a second interactive media node;
generate a rating score for the first post by applying one or more configuration parameters on the set of interaction values, the one or more configuration parameters indicating a set of one or more weighting values assigned to the set of interaction values; and
update a user interface to include the rating score for display at a user device.
